(19) United States
(12) Patent Application Publication
(10) Pub. No.: US 2021/0004772 A1
(43) Pub. Date: Jan. 7, 2021

(54) SYSTEM FOR EXCHANGE OF ELECTRONIC RESOURCE INSTRUMENTS USING A REAL TIME EXCHANGE NETWORK

(71) Applicant: BANK OF AMERICA CORPORATION, Charlotte, NC (US)

(72) Inventors: Heather Roseann Dolan, Sarasota, FL (US); Kimberly D. Dewberry, Charlotte, NC (US)

(73) Assignee: BANK OF AMERICA CORPORATION, Charlotte, NC (US)

(21) Appl. No.: 16/503,923

(22) Filed: Jul. 5, 2019

(51) Int. Cl. G06Q 20/04

(52) U.S. Cl. CPC G06Q 20/042

(57) ABSTRACT

Real-time interaction processing is provided by establishing an operable communication linkage between entities and/or organizations, including a real-time time resource exchange organization. The real-time interaction processing may include the use of an electronic resource instrument that includes interaction information. The real-time interaction processing may include capturing the interaction information from the electronic resource instrument (e.g., using one or more identifiers, such as codes, or the like) and automatically populating a resource exchange message with the interaction information in order to complete the real-time interaction processing. The electronic resource instrument may be operatively coupled to the resource exchange message and processed along with the resource exchange.

### FIELD

The present disclosure relates to utilizing a real-time exchange network for exchanging resources, and more particularly, for exchanging resources in accordance with electronic resource instruments.

### BACKGROUND

Traditional resource exchanges include the use of many different types of physical instruments. Moreover, the development of improved rapid interaction completion systems provides the ability to replace the use of many of the types of physical instruments. There exists a need for providing a more efficient exchange of resources within the rapid interaction completion system.

### BRIEF SUMMARY

The following presents a simplified summary of one or more embodiments of the invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

Embodiments of the present invention address these and/or other needs by providing an innovative system, method and computer program product for a real-time resource exchange that incorporates electronic instruments. Real-time interaction processing is provided by establishing an operable communication linkage between entities and/or organizations, including a real-time time resource exchange organization. The real-time interaction processing may include the use of an electronic resource instrument that includes interaction information. The real-time interaction processing may include capturing the interaction information from the electronic resource instrument (e.g., using one or more identifiers, such as codes, or the like) and automatically populating a resource exchange message with the interaction information in order to complete the real-time interaction processing. The electronic resource instrument may be operatively coupled to the resource exchange message and processed along with the resource exchange.

Some embodiments of the invention comprise a system, computer implemented product, and a computer implemented method for real-time interaction processing. The invention comprises receiving an indication of an interaction request for a first entity to provide resources to a second entity, identifying an electronic resource instrument for the interaction request, and creating a resource exchange message for providing the resources to the second entity. The invention further comprises operatively coupling the electronic resource instrument to the resource exchange message and exchanging the resources from a first entity resource pool of the first entity to a second entity resource pool of the second entity over a real-time resource exchange network in real-time using the resource exchange message.

In further accord with embodiments of the invention, the electronic resource instrument is created by capturing an image of a physical instrument.

In other embodiments of the invention, the electronic resource instrument is created by populating a representation of a physical instrument with interaction information.

In still other embodiments of the invention the electronic resource instrument comprises a representation of a physical negotiable instrument used to exchange the resources between the first entity and the second entity over a traditional resource exchange network.

In yet other embodiments of the invention, creating the resource exchange message for the interaction comprises capturing interaction information from the electronic resource instrument and populating the resource exchange message.

In further accord with embodiments of the invention, capturing the interaction information from the electronic resource instrument comprises capturing the interaction information from an image of the electronic resource instrument.

In other embodiments of the invention, creating the resource exchange message comprises capturing information from the electronic resource instrument.

In still other embodiments of the invention, the exchange of the resources from the first entity resource pool to the second entity resource pool over the real-time resource exchange network is performed by identifying routing information from the resource exchange message or the electronic resource instrument; accessing a routing directory; and exchanging the resources according to the routing directory.

In yet other embodiments of the invention, identifying the routing information from the resource exchange message or the electronic resource instrument comprises capturing one or more identifiers from the resource exchange message or the electronic resource instrument; and using the one or more identifiers to identify the second entity and a second organization resource pool for the interaction request.

In further accord with embodiments of the invention, the exchange of the resources from the first entity resource pool to the second entity resource pool over the real-time resource exchange network comprises exchanging the resources from the first entity resource pool to a first organization resource pool held by a resource exchange organization, and from a second organization resource pool held by the resource exchange organization to the second entity resource pool.

In other embodiments of the invention, exchange of the resources from the first entity resource pool to the second entity resource pool over the real-time resource exchange network further comprises exchanging the resources from the first organization resource pool to the second organization resource pool within the resource exchange organization.

In still other embodiments of the invention, the resources exchanged from the first entity resource pool to the second entity resource pool is settled in real-time.

In yet other embodiments of the invention, the one or more processing devices are further configured to execute the computer-readable program code to allow access to an interaction portal to monitor a plurality of interactions with resource exchanges between a plurality of entities.

In other embodiments of the invention, the one or more processing devices are further configured to execute the computer-readable program code to allow access to a report portal for reporting a plurality of interactions between a plurality of entities.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 provides a real-time interaction system environment, in accordance with some embodiments of the present disclosure.

FIG. 2 provides a block diagram of a real-time interaction flow environment, in accordance with some embodiments of the present disclosure.

FIG. 3 provides a process flow for processing electronic resource instruments in real-time resource exchanges, in accordance with some embodiments of the present disclosure.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.”

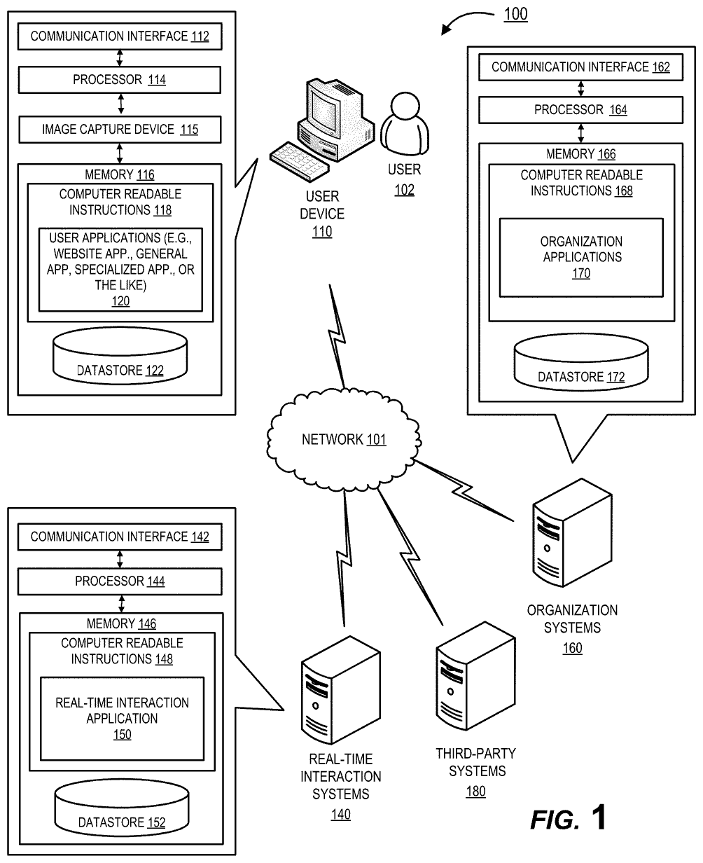

FIG. 1 provides a system that includes specialized systems and devices communicably linked across a distributive network of nodes required to perform the functions of implementing the real-time interaction processing system as described herein. FIG. 1 provides a real-time interaction processing system environment 100, in accordance with some embodiments of the present disclosure. As illustrated in FIG. 1, the real-time interaction system 140 (e.g., operated by one or more of the organizations, such as the resource exchange organization 210) is operatively coupled, via a network 101 to the user device 110, the one or more organization systems 160, and/or the one or more third-party systems 180. In this way, the real-time interaction system 140 can send information to, and receive information from, the user device 110, the organization systems 160, and/or the third-party systems 180. FIG. 1 illustrates only one example of some embodiments of the system environment 100, and it will be appreciated that in other embodiments one or more of the systems, devices, or servers may be combined into a single system, device, or server, or be made up of multiple systems, devices, or servers.

In accordance with embodiments of the invention, the term “entity” may be used instead of “user” or “party” (e.g., third party). As such, it should be understood that while the embodiments described herein discuss interactions between users, parties, and/or each other, it should be understood that the interactions may be described as occurring between entities (e.g., a first entity, second entity, or the like). Consequently, the term “entity” may include any user 102 acting on his/her own behalf, any party (e.g., business, company, third-party or the like) acing on its own behalf, or any user 102 acting on behalf of any party. An “organization” may refer to a business, company, or the like that maintains or operates the system or a portion thereof, including allowing for the exchange of resources between the various entities described herein.

The network 101 may be a system specific distributive network receiving and distributing specific network feeds and identifying specific network associated triggers. The network 101 may be a global area network (GAN), such as the Internet, a wide area network (WAN), a local area network (LAN), or any other type of network or combination of networks. The network 101 may provide for wireline, wireless, or a combination wireline and wireless communication between devices on the network 101.

In some embodiments, the entity (e.g., a user 102) utilizes an entity device (e.g., a user device 110) to implement the real-time interaction processing system over the network 101, such as by initiating, implementing, settling, and/or monitoring an interaction that involves a resource exchange. In some embodiments the entity (e.g., a user 102, party, or the like) is completing an interaction leveraging a real-time interaction system 140 with another entity (e.g., another user 102, another party, or the like)

In some embodiments, the user 102 has a user device 110, such as a mobile device (e.g., a mobile phone, smart phone, tablet, or the like) that may interact with a device 110 of another user 102 and/or the systems and devices described herein to allow for an interaction, in which resources are exchanged. In some embodiments, the user 102 may be a computing device user, a phone user, a mobile device application user, a customer (e.g., a resource pool holder or a person who has a resource pool, or the like), a system operator, database manager, a support technician, and/or employee of an entity. In some embodiments, identities of an individual may include online handles, usernames, identification numbers (e.g., Internet protocol (IP) addresses), aliases, family names, maiden names, nicknames, or the like.

As used herein, the term “user device” may refer to any device that employs a processor and memory and can perform computing functions, such as a personal computer or a mobile device, wherein a mobile device is any mobile communication device, such as a cellular telecommunications device (e.g., a cell phone or mobile phone), personal digital assistant (PDA), a mobile Internet accessing device, smartphone, or other mobile device. Other types of mobile devices may include pagers, wearable devices, mobile televisions, gaming devices, laptop computers, cameras, video recorders, audio/video player, radio, global positioning system (GPS) devices, or any combination of the aforementioned. In some embodiments, a device may refer to any computer system, platform, server, database, networked device, or the like. The device may be used by the user to access the system directly or through an application, online portal, internet browser, virtual private network, or other connection channel. The device may be a computer device within a network of connected computer devices that share one or more network storage locations.

It is understood that the servers, systems, and devices described herein illustrate some embodiments of the present disclosure. It is further understood that one or more of the servers, systems, and devices can be combined in other embodiments and still function in the same or similar way as the embodiments described herein.

As illustrated in FIG. 1, the user device 110 may generally include a processing device or processor 114 communicably coupled to devices such as, a memory device 116, user output devices (for example, a user display device, or a speaker), user input devices (such as a microphone, keypad, touchpad, touch screen, and the like), a communication device or network interface device 112, a power source, a clock or other timer, an image capture device 115 such as a camera, video recorder, or the like, a positioning system device, such as a geo-positioning system device like a GPS device or the like and the like. The processing device 114 may further include a central processing unit, input/output (I/O) port controllers, a graphics controller or GPU, a serial bus controller and a memory and local bus controller.

As used herein, the term “processing device” or “processor” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processor 114 may include functionality to operate one or more software programs or applications, which may be stored in the memory 116. For example, the processor 14 may be capable of operating applications such as the user application 120. The user application 120 may be configured to allow the user device 110 to transmit and receive data and instructions from the other devices and systems. The user device 110 comprises computer-readable instructions 118 and data storage 122 stored in the memory device 116, which in some embodiments include the computer-readable instructions 118 of a user application 120. In some embodiments, the user application 120 allows a user 102 to access and/or interact with content provided from an entity or an account maintained by an entity. In some embodiments, the user application 120 further includes features for accessing a real-time interaction clearing and settlement hub for viewing a life cycle of an interaction in real-time. In this way, the user 102 may have a holistic view of available resources instead of being reliant on the uncertainty of traditional, end-of-period settlement methods. The user application 120 may also allow the user to manage and view detailed information related to a plurality of past and/or pending interactions.

The processor 114 may be configured to use the communication interface 112 to communicate with one or more other devices on a network 101 such as, but not limited to the real-time interaction system 140, the organization systems 160, and/or the third-party systems 180. In this regard, the communication interface 112 may include an antenna operatively coupled to a transmitter and a receiver (together a “transceiver”), modem. The processor 114 may be configured to provide signals to and receive signals from the transmitter and receiver, respectively. The signals may include signaling information in accordance with the air interface standard of the applicable BLE standard, cellular system of the wireless telephone network and the like, that may be part of the network 101. In this regard, the user device 110 may be configured to operate with one or more air interface standards, communication protocols, modulation types, and access types. By way of illustration, the user device 110 may be configured to operate in accordance with any of a number of first, second, third, fourth, and/or fifth-generation communication protocols and/or the like. For example, the user device 110 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) or fifth-generation (5G) wireless communication protocols, and/or the like. The user device 110 may also be configured to operate in accordance with non-cellular communication mechanisms, such as via a wireless local area network (WLAN) or other communication/data networks. The user device 110 may also be configured to operate in accordance Bluetooth® low energy, audio frequency, ultrasound frequency, or other communication/data networks.

The user device 110 may also include a memory buffer, cache memory or temporary memory device operatively coupled to the processor 114. Typically, one or more applications 120 are loaded into the temporary memory during use. As used herein, memory may include any computer readable medium configured to store data, code, or other information. The memory 116 may include volatile memory, such as volatile Random-Access Memory (RAM) including a cache area for the temporary storage of data. The memory 116 may also include non-volatile memory, which can be embedded and/or may be removable. The non-volatile memory may additionally or alternatively include an electrically erasable programmable read-only memory (EEPROM), flash memory or the like.

FIG. 1 further provides a block diagram of the real-time interaction system 140, in accordance with embodiments of the invention. The real-time interaction system 140 generally comprises a communication interface 142, a processor 144, and a memory 146. The processor 144 is operatively coupled to the communication interface 142 and the memory 146. The processor 144 uses the communication interface 142 to communicate with the network 101 and other devices on the network 101, such as, but not limited to the user devices 110, the organization systems 160, and/or the third-party systems 180. As such, the communication interface 142 generally comprises a modem, server, transceiver, or other device for communicating with other devices on the network 101.

The real-time interaction system 140 comprises computer-readable instructions 148 stored in the memory 146, which in some embodiments include the computer-readable instructions 148 of a real-time interaction application 150. In some embodiments, the memory 146 includes data storage 152 for storing data related to the system environment, but not limited to data created and/or used by the real-time interaction application 150. In some embodiments, the datastore or data storage 152 of the real-time interaction system may store a record of one or more interactions (e.g., transactions) and/or electronic instruments.

Embodiments of the real-time interaction system 140 may include multiple systems, servers, computers or the like maintained by one or many organizations. FIG. 1 merely illustrates one of those systems that, typically, interacts with many other similar systems, such as the user devices 110, the organization systems 160, and/or third-party systems 180, to complete and settle interactions over real-time resource exchange networks. In some embodiments, the real-time interaction system 140 may be part of an organization system 160, third-party system 180, or vice versa. The real-time interaction system 140 may communicate with the user devices 110, organization systems 160, and/or third-party systems 180 via a secure connection generated for secure encrypted communications between the systems.

In some embodiments of the real-time interaction system 140, the memory 146 stores a real-time interaction application 150. In some embodiments of the present disclosure, the real-time interaction application 150 may associate with applications having computer-executable program code that instructs the processor 144 to operate the network communication interface 142 to perform certain communication functions described herein. In some embodiments, the computer-executable program code of an application associated with the real-time interaction application 150 may also instruct the processor 144 to perform certain logic, data processing, and data storing functions of the application.

The processor 144 is configured to use the communication interface 142 to gather data, such as data corresponding to interactions from various data sources such as the user devices 110, organization systems 160, and/or third-party systems 180. The processor 144 stores the data that it receives in the memory 146. The memory 146 may further comprise stored user account information (e.g., account number, routing number, user identifying information, etc.).

FIG. 1 further provides a block diagram of one or more organization systems 160, in accordance with embodiments of the invention. In some embodiments, the organization systems 160 may refer to the systems of organizations that hold resources for the entities and/or for other parties, facilitates interactions between the entities and/or organizations, or the like. The organization systems 160 generally comprise a communication interface 162, a processor 164, and a memory 166. The processor 164 is operatively coupled to the communication interface 162 and the memory 166. The processor 164 uses the communication interface 162 to communicate with the network 101 and other devices on the network 101, such as, but not limited to the user devices 110, the real-time interaction systems 140, and/or the third-party systems 180. As such, the communication interface 162 generally comprises a modem, server, transceiver, or other device for communicating with other devices on the network 101.

The organization systems 160 further comprise computer-readable instructions 168 stored in the memory 166, which in some embodiments include the computer-readable instructions 168 of an organization application 170. In some embodiments, the memory device 166 includes data storage 172 for storing data related to the system environment 100, but not limited to data created and/or used by the organization systems 160, the user devices 110, or the real-time interaction systems 140.

Embodiments of the organization systems 160 may include multiple systems, servers, computers or the like maintained by one or many organizations. In some embodiments, the real-time interaction systems 140 may or may not be distinct from the organization systems 160. The organization systems 160 may communicate with the real-time interaction systems 140 via secure connections generated for secure encrypted communications between the systems.

In some embodiments of the organization systems 160, the memory 166 stores an organization application 170. In some embodiments, the memory 166 stores data including, but not limited to, at least portions of interaction records comprising a record of one or more real-time interactions. In some embodiment of the disclosure, the organization application 170 may associate with applications having computer-executable program code that instructs the processor 164 to operate the network interface 162 to perform certain communication functions described herein. In some embodiments, the computer-executable program code of an application 170 may also instruct the processor 164 to perform certain logic, data processing, and data storing functions of the application.

The processor 164 is configured to use the communication interface 162 to gather data, such as data corresponding to interactions, such as resource exchange messages of real-time interactions, as well as one or more instruments associated with the interactions between the entities. In some embodiments, the processor 164 may be configured to identify electronic instruments associated with resource exchanges and use the electronic documents to enter into the real-time interactions, complete the real-time interactions, and/or monitor the real-time interactions, and store the forgoing (e.g., in data store 172, or the like). The organization systems 160 may maintain a detailed record of a series of interactions that are updated in real-time based the real-time interactions taking place. In this way, the organization systems 160 (e.g., individual organizations, resource exchange organization, or the like) may track interactions and resource flows accurately in real-time instead of relying on traditional end-of-period, batch-processing clearing and settlement methods.

The one or more third party systems 180 may comprise the systems that a third party (e.g., a product provider) uses to enter into interactions with users 102. For example, the third-party may be a merchant that provides a product (e.g., goods or services) to a user 102 during an interaction, and collects resources from the user 102 (e.g., or an entity or organization of the user 102) through the one or more organization systems 160. It should be understood that both the user 102 and the product provider party may have resource pools with one or more organizations in order to allow for a resource transfer associated with the interaction.

As such, it should be understood, and as will be described herein in further detail, the interaction may occur between two users 102 using the user devices 110 on behalf of themselves, between a user 102 and a third-party (directly with a third-party or with another user operating on behalf of the third-party), and/or between two parties (directly with each other).

As used herein, a “real-time interaction” refers to a resource exchange (or transfer) between users and/or entities participating in and leveraging a settlement network operating in real-time (e.g., twenty-four hours a day, seven days a week), wherein settlement of the interaction occurs at or very close in time to the time of the interaction (i.e., real-time). A real-time interaction may include a resource exchange, wherein a real-time interaction system enables participants to initiate credit transfers, receive settlement for credit transfers, and make available to a receiving participant funds associated with the credit transfers in real-time, wherein the credit transfer may be final and irrevocable. Real-time interactions and resource exchanges provide marked improvements over conventional interaction clearing and transfer settlement methods (e.g., automated clearing house (ACH), wire, or the like) which can require several hours, days, or longer to receive, process, authenticate an interaction and resource exchange (i.e., clearing), and make funds available to the receiving participant which may, in total, require several back-and-forth communications between involved organizations (e.g., financial institutions). In some cases, conventional settlement methods may not be executed until the end of the business day (EOB), wherein resource exchanges are settled in batches between organizations.

Real-time interactions reduce settlement time by providing pre-authentication or authentication at the time of a requested interaction in order to enable instantaneous or near-instantaneous (i.e., real-time) resource exchange and settlement between organizations at the time of the interaction, wherein resources may be made immediately available to a receiving entity (i.e., payee) following completion of the interaction. Examples of real-time interactions include business to business interactions (e.g., supplier exchanges), business to consumer interactions (e.g., legal settlements, insurance claims, employee wages), consumer to business interactions (e.g., bill pay, hospital co-pay, payment at point-of-sale), and peer to peer (P2P) interactions (e.g., repayment or remittance between friends and family). In a specific example, a real-time interaction may be used for payment of a utility bill on the due date of the bill to ensure payment is received on-time and accruement of additional fees due to late payment is avoided. In some embodiments, a negotiable instrument (e.g., check, or the like) may be used to exchange resources; however, a real-time interaction may be used to make the resource exchange using the negotiable instrument. In another example, real-time interactions may be especially beneficial for small entities and users (e.g., small merchants/businesses) that may have a heavier reliance on short-term resources and may not prefer to wait days for resource settlements.

Real-time interactions not only provide settlement immediacy, but also provide assurance, fraud reduction, and bank-grade security to resource exchanges due to the inherent nature of the resource exchange and user authentication infrastructure. Further, real-time interactions may reduce payment processing costs due to the simplified nature of required communication when compared to conventional settlement methods. In some embodiments, real-time interaction systems further include information and conversation tools that financial institutions may utilize to enhance a settlement experience for the entities.

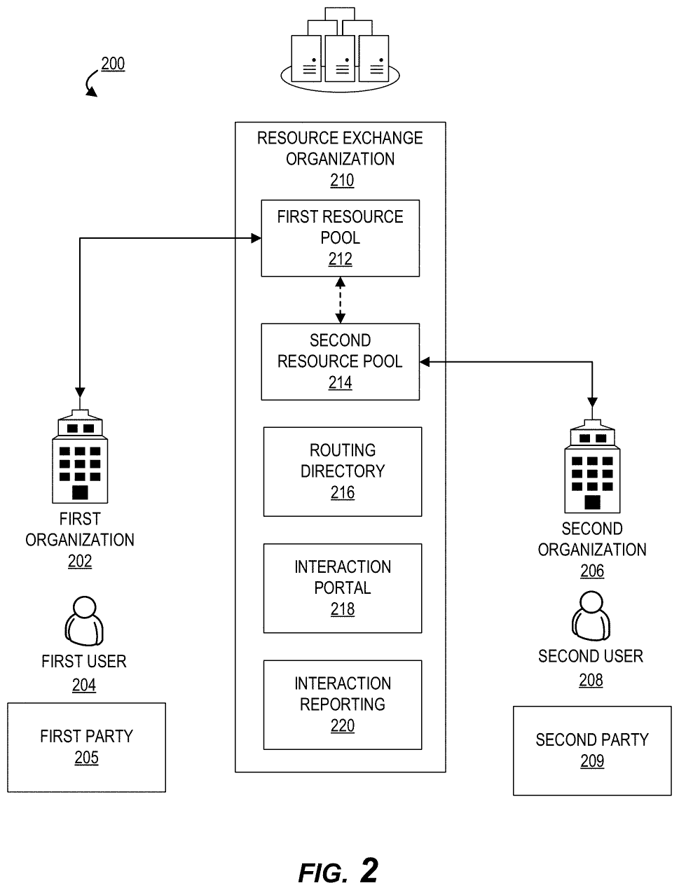

A system leveraging a real-time resource exchange network allows for an interaction with a resource exchange to be completed between participating entities via an intermediary clearing house acting in the role of a neutral party. Organization resource pools (e.g., financial institution resource pools) are held at the resource exchange organization (e.g., clearing house) and administered by both the organization and the resource exchange organization. In this way, the resource exchange organization is able to exchange resources between organization resource pools on behalf of the organizations in order to settle interactions between entities affiliated with the organizations (e.g., customers of the organizations). A real-time interaction network flow is discussed in further detail with respect to FIG. 2.

FIG. 2 illustrates a block diagram of a real-time interaction environment 200, in accordance with some embodiments of the invention. In the illustrated environment, a first user 204 (e.g., acting on his/her own benefit, for the benefit of a first party—a first merchant, or the like) is associated with (e.g., a customer of) a first organization 202 (e.g., first financial institution, or the like) and a second user 208 (e.g., acting on his/her own benefit, for the benefit of a second party—a second merchant, or the like) is associated (e.g., a customer of) a second organization 206 (e.g., a second financial institution). A resource exchange organization 210 (e.g., a real-time interaction clearing house, or the like) may facilitate (e.g., hold, service, or the like) a first resource pool 212 (e.g., first account, or the like) associated with the first organization 202 (e.g., first financial institution, or the like) and a second resource pool 214 (e.g., second account, or the like) associated with the second organization 206 (e.g., second financial institution, or the like). The first resource pool 212 and the second resource pool 214 are accessible by each associated organization (e.g., the first organization 202 and the second organization 206, respectively) and the resource exchange organization 210, which acts as a trusted intermediary during settlement between the organizations affiliated with each entity (e.g., each user 204, 208, and/or party 205, 209). Resources (e.g., funds, or the like) may be transferred by each organization (e.g., first organization 202, second organization 206, or the like) to and from their associated resource pools 212, 214 with the resource exchange organization 210. Exchanges between the first resource pool 212 and the second resource pool 214 are administered by the resource exchange organization 210 pending authentication and authorization by participating entities of each resource exchange. It should be understood that since the resource exchange organization 210 maintains resource pools for each organization, the transfer of resources may be made in real-time as described herein (e.g., within 10, 5, or the like seconds). The amount of resources within the resource pools 212, 214 of the organizations 202, 206 may be estimated based on the estimated number of interactions and estimated amounts thereof that each organization 202, 206 typically enters on behalf of its entities (e.g., customers).

It should be further understood that the resource exchange organization 210 may also have a routing directory 216 (e.g., stored in a memory, database, and/or the like). The routing directory 216 may be utilized by the resource exchange organization 210, the other organizations 202, 206, and/or third parties in order to determine where and how to rout the real-time resource exchange for each interaction. As will be discussed in further detail herein, a real-time resource exchange message and/or an electronic document associated therewith may include one or more identifiers (e.g., token, QR Code, barcode, mobile number, e-mail address, or the like) that the resource exchange organization 210 may utilize by looking up the one or more identifiers in the routing directory 216 in order to determine to which resource pool (e.g., second resource pool 214), organization (e.g., second organization), and/or entity (e.g., second entity—second user 208 and/or second party 209) to which the resources should be routed for the interaction. The resource directory 216 (e.g., one or more resource directories) may also be used to determine the processing, error codes, resource exchange treatments, or the like that may be used to process interactions and/or the associated resource exchanges.

In some embodiments, the resource exchange organization 210 may further utilize an interaction portal module 218. The interaction portal module 218 may store information regarding the interactions and resources for each of the interactions of an organization (e.g., incoming and/or outgoing resource exchanges). Moreover, the resource exchange organization 210 may also utilize an interaction reporting module 220 that allows for reporting regarding the interactions of an organization. For example, the interaction reporting module 220 may be used to send notifications to the organizations and/or entities related to the interactions that are entered into, in process, and/or completed, and interaction information related thereto.

As an illustrative example, the first user 204 and the second user 208 are participants of a real-time interaction, wherein the first user 204 (e.g., the payor) initiates a credit transfer to the second user 208 (e.g., the payee). The first user 204 may initiate the exchange from the first financial institution 202, wherein the first user 204 provides authentication credentials to authenticate the identity of the first user 204 and to validate that a first user resource pool of the first user 204 held at the first financial institution 202 contains at least a sufficient amount of available resources to fulfill the resource exchange. While in some embodiments, the first user 204 may initiate the exchange from a physical, brick-and-mortar location of the first organization 202, in alternative embodiments described herein, the exchange may be initiated from other locations wherein the first user 204 is not required to be at a brick-and-mortar location (e.g., initiated via an electronic application, a website, or the like, such as through a user device 110).

The first user 204, as the sending participant (e.g., payor), may be required to authenticate his or her identity by providing credentials to the associated organization (e.g., first organization 202, resource exchange organization 210, or the like). For example, authentication information may include account numbers, routing numbers, PIN numbers, username and password, date of birth, social security number, or the like, or other authentication information as described herein. In some embodiments, authentication may comprise multi-factor or multi-step authentication in accordance with information security standards and requirements.

As such, as used herein “authentication credentials” is any information that can be used to identify a user. For example, a system may prompt a user to enter authentication information such as a username, a password, a personal identification number (PIN), a passcode, biometric information (e.g., voice authentication, a fingerprint, and/or a retina scan), an answer to a security question, a unique intrinsic user activity, such as making a predefined motion with a user device 110. This authentication information may be used to authenticate the identity of the user (e.g., determine that the authentication information is associated with the account) and determine that the user 102 has authority to access an account or system. The entity or organization may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing device, or the like to access, write, delete, copy, or modify data within at least a portion of the system.

Returning to the illustrative example, upon initiating an interaction, the first user 204 becomes obligated to exchange the resources for the interaction. As such, in some embodiments the interaction, and resource exchange thereof, cannot be canceled by the first user 204 following initiation and communication to an intermediary and/or a receiving participant of the interaction. The second user 208, as the receiving participant (e.g., the payee), receives communication to accept the resource exchange, in some embodiments following similar user authentication requirements made by the first user 204. Communication between participants for the interaction may be transmitted between the organizations 202, 206 via the resource exchange organization 210, which directs the resource exchange to the appropriate organizations 202, 206 associated with the participants (e.g., organizations, entities, or the like). The exchange of resources occurs between the resource pools 212, 214 of the financial institutions 202, 206 on behalf of their respective users 204, 208, wherein the interaction may be settled immediately, concurrent with the resource exchange. As settlement occurs between the representative organizations (e.g., financial institutions, clearing house), debiting and crediting of individual user resource pools may be managed at each organization with their individual customer and through the organization resource pools at the resource exchange organizations 210. As the interaction is settled immediately, resources may be made available for use in real-time, which may be immediate or near real-time. It should be understood that real-time may be within minutes, seconds, (e.g., within 60, 40, 20, 15, 10, 5, 4, 3, 2, 1, or the like seconds), or the like.

It should be understood that while the illustrated embodiments of FIG. 2 depict only first and second users 204, 206, organizations 202, 206, and resource pools 212, 214, other embodiments of a real-time interaction network may comprise a plurality of resource pools for a plurality of organizations (e.g., financial institutions), and/or for a plurality of entities. In some embodiments, the real-time interaction environment 200 may further comprise more than one resource exchange organization 210 or at least a plurality of resource exchange organizations (e.g., TCHs, the Federal Reserve, and the like), which cooperate within a resource exchange network to receive and process interaction requests as described herein. It should be understood that the organizations 202, 206 may include one or more community banks, regional banks, credit unions, corporate banks, direct connect financial institutions, or the like. When the organization is a “financial organization”, such as a “financial institution”, these terms may mean any organization that processes financial transactions (e.g., a transfer of funds or other monetary or financial resources) including, but not limited to, banks, credit unions, savings and loan associations, investment companies, stock brokerages, asset management firms, insurance companies and the like. In specific embodiments of the invention, use of the term “bank” is limited to a financial entity in which account-bearing customers conduct financial transactions, such as account deposits, withdrawals, transfers and the like.

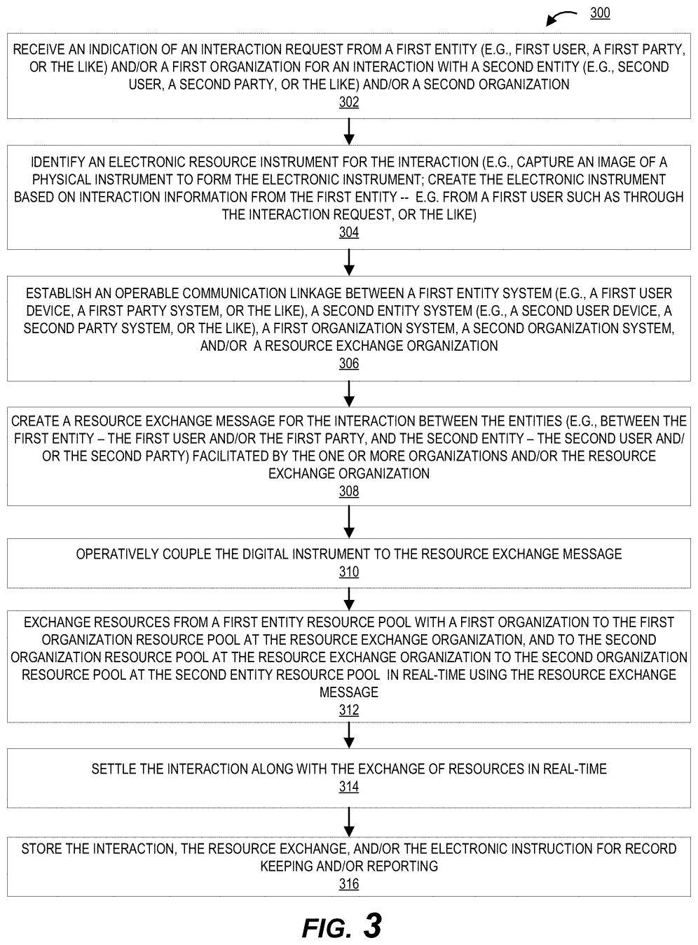

FIG. 3 provides a process flow for processing electronic resource instruments in real-time resource exchanges in association with interactions, in accordance with some embodiments of the present disclosure. Block 302 of FIG. 3 illustrates that the system (e.g., the real-time interaction system, the system of one or more of the organizations, such as the first organization, resource exchange organization, or the like) receives an indication of an interaction request from a first entity (e.g., a first user 202, first party 205, or the like) for an interaction with a second entity (e.g., a second user 208, second party 209, or the like). The interaction request may include a request to exchange resources with (e.g., provide resources to) the second entity in exchange for a product (e.g., good or service) provided to the first entity.

Block 304 of FIG. 3 illustrates that the system may identify an electronic resource instrument for the interaction. The electronic resource instrument may be an electronic version of a physical negotiable instrument (e.g., a personal check, cashier's check, agreement, or other like paper instrument) that may be used to exchange resources in association with an interaction. For example, the system may identify an image of a physical negotiable instrument (e.g., a check, or the like) that was captured by a first user 204 using an image capture device 115 of the user device 110. Alternatively, the interaction request from the first entity may include interaction information that allows the system (e.g., organization system, real-time interaction system 140, or the like) to create an electronic version of a negotiable instrument without having to create a physical negotiable instrument. Alternatively, or additionally, the first entity may provide interaction information for the interaction along with or after making the interaction request. As such, the interaction request and/or the electronic resource instrument may include information for the interaction and/or the associated resource exchange, such as but not limited to the payee, interaction amount, interaction communication for the payee, the one or more identifiers (described below), or the like.

FIG. 3 further illustrates in block 306 that a communication linkage is established between the systems. For example, between two or more of the first entity system (e.g., first user device, party system, or the like), the second entity system (e.g., second user device, party system, or the like), a first organization system, a second organization system, and/or the resource exchange organization system. The communication linkage allows for the interaction and the associated resource exchange.

Block 308 of FIG. 3 illustrates that a resource exchange message for the interaction between the entities (e.g., first entity, second entity) is created. The resource exchange message may include a real-time message that conforms to ISO 2000 messaging for real-time interactions. In some embodiments of the invention, the resource exchange message may be populated with information from the interaction request. Alternatively, or additionally, the resource exchange message may be populated with information identified from the electronic resource instrument (e.g., image of the physical negotiable instrument, electronic negotiable instrument created as part of the interaction request, or the like). That is, interaction information may be captured from the electronic resource instrument (e.g., using metadata, using optical character recognition, or the like) in order to populate the resource exchange message automatically (e.g., at least partially populate).

FIG. 3 further illustrates in block 310 that the electronic resource instrument may be operatively coupled to the resource exchange message. In typical interactions, the resource exchange message does not have any documentation associated with the message. Moreover, when processing interactions using traditional rails (e.g., ACH, wires, or the like that take days) the communications over the rails do not have the capability to include documents, messages between the entities, or the like. As such, additional applications and programing would be required to link any traditional interactions to any documentation separately and apart from the traditional processing rails. Unlike the traditional processing, the real-time exchange messages allow for the inclusion of other information besides the resource exchange details, as such the resource exchange message can include communications between the entities, descriptions of the interactions, instructions for the entities, and/or the interaction resource instrument (e.g., check, agreement, or the like) such that any tracking, monitoring, reporting, or other like functions can be performed directly by the entities using the resource exchange message without requiring specific applications and/or systems dedicated to tracking such information which would be required with traditional interaction processing.

Moreover, it should be understood that in some situations the entities may want to have a representation of the interaction, for example, an electronic representation of the interaction (e.g., that can be displayed on a mobile device, printed for creating a paper trail, or the like). As such, the resource exchange message and/or the electronic resource instrument may be used by the entities and/or organizations to verify resource exchanges for the interaction. For example, the electronic resource instrument may be used in particular situations in which an entity is entering into an interaction for property (e.g., land, cars, or the like), in which paper negotiable instruments provide a potential security issue due to loss, damage, misappropriation, or the like of the paper negotiable instruments (e.g., which are typically for large sums of funds).

FIG. 3 further illustrates in block 312 that after the resource exchange message is created, it used to facilitate the resource exchange from the first entity resource pool with the first organization, to the first organization resource pool at the resource exchange organization. Furthermore, the resources are exchanged from the second organization resource pool to the second entity resource pool. Before, during or after these exchanges the resources are exchanged between the first organization resource pool and the second organization resource pool. It should be understood that the resources are exchanged in real-time based on the resource exchange message. In some embodiments, the resource exchange message may include interaction information, such as one or more identifiers, which the resource exchange organization may utilize in order make the resource exchange. For example, the resource exchange organization may access a routing directory 216 and use the one or more identifiers to identify the second resource pool 214 and/or the second organization 206, second user 208, and/or second party 209 to which the resources are to be transferred.

Block 314 of FIG. 3 further illustrates that the interaction is settled along with the exchange of resources in real-time. For example, the accounting of the resource exchanges between the entities and/or the organizations are made by the resource exchange organization, the first organization, and/or the second organization (e.g., within a general ledger to which the organizations have access and/or within individual organization ledgers, or the like).

FIG. 3 further illustrates in block 316 that the interaction, the resource exchange, and/or the electronic resource instrument are stored for record keeping and/or reporting (e.g., in the interaction portal module 218, interaction reporting module 220, or the like).

In some embodiments of the invention, it should be understood that additional security measures may be put in place in order to verify the parties involved in the interaction before the resource exchange is made. It should be understood that since the real-time resource exchange results in immediate transfer of resources between the entities that cannot be canceled, additional security measures may be put in place to reduce unauthorized interactions and/or resource exchanges. For example, additional verification may be required before the resource exchange is made when a new payee is being identified, a threshold resource amount is reached for the interaction (e.g., over $500, $1000, $2000, $5000, or the like), multiple interactions are entered into with the same entity, multiple interactions are made with entities located in particular regions, or the like occurs. For example, the additional verification may include two-factor authentication, security questions, passwords, verification from different user devices, or the like in order to provide a higher level of confidence that the interaction is not a misappropriated interaction.

In some embodiments of the invention, before each resource exchange is allowed to occur, or in specific situations when additional verification is required (as described above), a first user signature (e.g., written, electronic—specific character strings that serve as an electronic signature, or the like) may be captured from the electronic resource instrument (e.g., through the image captured of the physical negotiable instrument, from the digitally created electronic resource instrument, or the like). The captured signature may be compared to a stored signature for the first user in order to determine if the captured signature and stored signature are the same (e.g., within a set confidence level, such as 80, 85, 90, 95, or the like percent). As such, in some embodiments, the organization (e.g., first organization 202, second organization 206, resource exchange organization 210, or the like) may store a user signature provided by the user for future use for authentication purposes. Consequently, the captured user signature and the stored user signature may be used to provide additional security to the resource exchanges discussed herein.

It should be understood that the resource exchange messages (e.g., the ISO messages, or the like) used for real-time interactions are much more robust than typical automated clearing houses (AHC) and wire communications for typical interactions. The resource exchange messages are much faster (e.g., within seconds) and much more secure (e.g., no physical instruments are used). In some embodiments of the invention no account numbers need to be used, and instead the one or more identifiers are all that is required to exchange resources.

In some embodiments, the systems described herein may comprise a plurality of subsystems having a plurality of subsystem formats, wherein the system may transmit the update to the plurality of subsystems based on a subsystem format associated with each of the individual subsystems. For example, a system may comprise subsystems having a mixture of real-time interaction formats and batch processing formats. The system is configured to transmit the update to each of the subsystems individually depending on an associated subsystem format of each subsystem.

As will be appreciated by one of ordinary skill in the art, the present invention may be embodied as an apparatus (including, for example, a system, a machine, a device, a computer program product, and/or the like), as a method (including, for example, a process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function. As such, once the software and/or hardware of the claimed invention is implemented the computer device and application-specific circuits associated therewith are deemed specialized computer devices capable of improving technology associated with real-time payment clearing and settlement.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a special purpose computer for real-time payment clearing and settlement, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

### INCORPORATION BY REFERENCE

To supplement the present disclosure, this application further incorporates entirely by reference the following commonly assigned patent applications:

| | U.S. patent | | |
|---|---|---|---|
| | application | | |
| Docket Number | Ser. No. | Title | Filed On |
| 9137US1.014033.3474 | To be assigned | SYSTEM FOR | Concurrently |
| | | PROCESSING | herewith |
| | | ELECTRONIC | |
| | | RESOURCE | |
| | | REQUESTS | |
| | | USING A REAL | |
| | | TIME | |
| | | EXCHANGE | |
| | | NETWORK | |

What is claimed is:

1. A system for real-time interaction processing, the system comprising:
one or more memory devices with computer-readable program code stored thereon; and
one or more processing devices operatively coupled to the one or more memory devices, wherein the one or more processing devices are configured to execute the computer-readable program code to:
receive an indication of an interaction request for a first entity to provide resources to a second entity;
identify an electronic resource instrument for the interaction request;
create a resource exchange message for providing the resources to the second entity;
operatively couple the electronic resource instrument to the resource exchange message; and
exchange the resources from a first entity resource pool of the first entity to a second entity resource pool of the second entity over a real-time resource exchange network in real-time using the resource exchange message.

2. The system of claim 1, wherein the electronic resource instrument is created by capturing an image of a physical instrument.

3. The system of claim 1, wherein the electronic resource instrument is created by populating a representation of a physical instrument with interaction information.

4. The system of claim 1, wherein the electronic resource instrument comprises a representation of a physical negotiable instrument used to exchange the resources between the first entity and the second entity over a traditional resource exchange network.

5. The system of claim 1, wherein creating the resource exchange message for the interaction comprises capturing interaction information from the electronic resource instrument and populating the resource exchange message.

6. The system of claim 5, wherein capturing the interaction information from the electronic resource instrument comprises capturing the interaction information from an image of the electronic resource instrument.

7. The system of claim 5, wherein creating the resource exchange message comprises capturing information from the electronic resource instrument.

8. The system of claim 1, wherein the exchange of the resources from the first entity resource pool to the second entity resource pool over the real-time resource exchange network is performed by:
identifying routing information from the resource exchange message or the electronic resource instrument;
accessing a routing directory; and
exchanging the resources according to the routing directory.

9. The system of claim 8, wherein identifying the routing information from the resource exchange message or the electronic resource instrument comprises:
capturing one or more identifiers from the resource exchange message or the electronic resource instrument; and
using the one or more identifiers to identify the second entity and a second organization resource pool for the interaction request.

10. The system of claim 1, wherein the exchange of the resources from the first entity resource pool to the second entity resource pool over the real-time resource exchange network comprises exchanging the resources from the first entity resource pool to a first organization resource pool held by a resource exchange organization, and from a second organization resource pool held by the resource exchange organization to the second entity resource pool.

11. The system of claim 10, wherein the exchange of the resources from the first entity resource pool to the second entity resource pool over the real-time resource exchange network further comprises exchanging the resources from the first organization resource pool to the second organization resource pool within the resource exchange organization.

12. The system of claim 1, wherein the resources exchanged from the first entity resource pool to the second entity resource pool is settled in real-time.

13. The system of claim 1, wherein the one or more processing devices are further configured to execute the computer-readable program code to allow access to an interaction portal to monitor a plurality of interactions with resource exchanges between a plurality of entities.

14. The system of claim 1, wherein the one or more processing devices are further configured to execute the computer-readable program code to allow access to a report portal for reporting a plurality of interactions between a plurality of entities.

15. A computer-implemented method for real-time interaction processing, the computer-implemented method comprising:
receiving, by one or more processors, an indication of an interaction request for a first entity to provide resources to a second entity;
identifying, by the one or more processors, an electronic resource instrument for the interaction request;
creating, by the one or more processors, a resource exchange message for providing the resources to the second entity;
operatively coupling, by the one or more processors, the electronic resource instrument to the resource exchange message; and
exchanging, by the one or more processors, the resources from a first entity resource pool of the first entity to a second entity resource pool of the second entity over a real-time resource exchange network in real-time using the resource exchange message.

16. The method of claim 15, wherein the electronic resource instrument is created by capturing an image of a physical instrument.

17. The method of claim 15, wherein the electronic resource instrument is created by populating a representation of a physical instrument with interaction information.

18. The method of claim 15, wherein the electronic resource instrument comprises a representation of a physical negotiable instrument used to exchange the resources between the first entity and the second entity over a traditional resource exchange network.

19. The method of claim 15, wherein creating the resource exchange message for the interaction request comprises capturing interaction information from the electronic resource instrument and populating the resource exchange message.

20. A computer program product for real-time interaction processing, the computer program product comprising at least one non-transitory computer-readable medium having computer-readable program code portions embodied therein, the computer-readable program code portions comprising:
an executable portion configured to receive an indication of an interaction request for a first entity to provide resources to a second entity;
an executable portion configured to identify an electronic resource instrument for the interaction request;
an executable portion configured to create a resource exchange message for providing the resources to the second entity;
an executable portion configured to operatively couple the electronic resource instrument to the resource exchange message; and
an executable portion configured to exchange the resources from a first entity resource pool of the first entity to a second entity resource pool of the second entity over a real-time resource exchange network in real-time using the resource exchange message.
